(19) United States
(12) Patent Application Publication
(10) Pub. No.: US 2001/0027350 A1
(43) Pub. Date: Oct. 4, 2001

(54) Manufacturing management system, manufacturing management method, and recording medium storing programs for executing the method

(76) Inventors: Yasutaka Koga, Yokohama-shi (JP); Masaki Kageyama, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/817,152

(22) Filed: Mar. 27, 2001

(30) Foreign Application Priority Data
Mar. 28, 2000 (JP) 2000-087821

(51) Int. Cl. G06F 19/00

(52) U.S. Cl. 700/95

(57) ABSTRACT

A manufacturing management apparatus comprising an interface which input manufacturing order information from an enterprise resource planning system, an information management device which manages data concerning individual parts employed for manufacture according to the manufacturing order information, and an information display device which generates manufacturing information in a manufacturing process employing the parts based on managed data and displays the manufacturing information in the form of management action reference auxiliary information.

### CROSS-REFERENCE TO RELATED APPLICATIONS

This application is based upon and claims the benefit of priority from the prior Japanese Patent Application No. 2000-087821, filed Mar. 28, 2000, the entire contents of which are incorporated herein by reference.

### BACKGROUND OF THE INVENTION

1. Field of the Invention

The present invention relates to a manufacturing control system, a manufacturing management method, and software employed for the manufacturing management method in order to grasp a production state of products in individual processes in production lines, and reflect the result through a manufacturing process.

2. Description of the Related Art

In a conventional manufacturing management system, real time information and counting information are not clearly distinguished from each other, and a management action reference is not included. Thus, even if production information is displayed, it has been difficult to take a speedy management action.

Further, as a method of inputting a product failure, although failure item input is encoded, there has been employed a method of selecting a failure item from the list. Thus, if the number of failures increases, an operation for inputting such items has been cumbersome.

Recently, there has been developed techniques concerning a manufacturing management system, which is disclosed in Jpn. Pat. Appln. KOKAI Publication No. 10-254537, and Jpn. Pat. Appln. KOKAI Publication No. 9-26588 or the like.

In the above described conventional manufacturing management system, real time information provided in production lines and counted information having time lag are clearly distinguished from each other. Thus, since the system has not included a specific management action reference for human being, even if production information is displayed, it has been difficult to cause a human being to take a speedy management action. Further, there has been employed a method of inputting failures that are produced in production lines by selecting them from the list every time such failure is produced. Thus, there has been a problem that, if the number of failures increases, an operation for inputting such items becomes cumbersome.

Further, in the above described patent publications, there have been described that real time information and counting information are displayed to be clearly distinguished from each other in a production management system, and that a proper management action can be taken based on the real time information in the production management system.

However, in the above known examples as well, there is a problem that an instruction is not supplied to a human being in the clear form of a “management action reference” representing who takes action and when and how to take action.

It is an object of the present invention to provide a manufacturing management system for clearly distinguishing real time information and counting information, and displaying a management action reference of a human being, thereby causing the human being to take a speedy management action based on the thus displayed manufacturing information.

In addition, it is another object of the present invention to provide a manufacturing management system for sequentially inputting failures from an upper category, and reducing the number of items to be selected at the time of one input, thereby simplifying an operation for inputting a plurality of failures.

Further, it is still another object of the present invention to provide a manufacturing management method using this manufacturing management system, and a storage medium storing software related to this manufacturing management method.

### BRIEF SUMMARY OF THE INVENTION

According to a first aspect of the present invention, there is provided a manufacturing management apparatus associated with an enterprise resource planning system for performing management concerning a manufacturing product quantity and a manufacturing process, comprising: an interface configured to input manufacturing order information from the enterprise resource planning system; an information management device configured to manage data concerning individual parts employed for manufacture according to the manufacturing order information, and output information to be provided to the parts; and an information display device configured to generate manufacturing information in a manufacturing process employing the parts based on data managed by the information management device, and display the manufacturing information in the form of management action reference auxiliary information.

According to a second aspect of the present invention, there is provided a manufacturing management apparatus associated with an enterprise resource planning system for instructing a product manufacturing plan, comprising: a database configured to store information generated from the enterprise resource planning system; a label issuing device configured to issue to each part a bar code label concerning the each part based on storage information in the database; an executing device configured to read a bar code of a bar code label of each part that flows a manufacturing line, to store readout bar code data in the database; and a display device configured to generate manufacturing information in a manufacturing process based on information stored in the database, and displaying the manufacturing information as management action reference auxiliary information.

According to a third aspect of the present invention, there is provided a manufacturing management method comprising: inputting manufacturing order data from an enterprise resource planning system for performing management concerning a manufacturing product quantity or a manufacturing process; managing data concerning individual parts employed for manufacture according to the manufacturing order data to output information to be provided to the parts;

generating and displaying manufacturing information in the manufacturing process using the parts based on the data managed in the managing step; and determining a management action reference by referring to the displayed manufacturing information.

According to a fourth aspect of the present invention, there is provided a manufacturing management method comprising: storing in a database, information generated from an enterprise resource planning system for instructing a product manufacturing plan; issuing to each part, a bar code label concerning the part based on storage information in the database; reading a bar code of a bar code label of each part that flows a manufacturing line to obtain bar code data, collecting the bar code data to store the collected bar code data in the database; generating manufacturing information in a manufacturing process based on the information stored in the database; and displaying the manufacturing information as management action reference auxiliary information on a display device.

According to a fifth aspect of the present invention, there is provided a computer program product for operating a computer, comprising: means for instructing the computer to input a manufacturing instruction data from a superior system for performing management concerning a manufacturing product quantity and a manufacturing process; means for instructing the computer to manage data concerning individual parts employed for manufacture according to the manufacturing instruction data to output information to be provided to the parts; and means for instructing the computer to generate and display manufacturing information in the manufacturing process as management action reference auxiliary information using the parts based on the data managed in accordance with the managing instruction means.

According to a six aspect of the present invention, there is provided a computer program product for operating a computer, comprising: means for instructing the computer to store in a database, information generated from an enterprise resource planning system for instructing a product manufacturing plan; means for instructing the computer to issue to each part, a bar code label concerning the each part based on storage information in the database; means for instructing the computer to read a bar code of a bar code label of each part that flows a manufacturing line, collect data, and then, store collected data in the database; means for instructing the computer to generate manufacturing information in a manufacturing process based on the information stored in the database; and means for instructing the computer to display the manufacturing information as management action reference auxiliary information on a display device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1A to FIG. 1C are conceptual views each showing a system configuration of, and a data flow in, a manufacturing information management system according to a first embodiment of the present invention;

FIG. 2A to FIG. 2C are views each showing a configuration table showing a configuration of individual manufacturing history data in a data management device according to one embodiment of the present invention, and an individual failure history data configuration;

FIG. 3 is a view showing a configuration of a current state data in the data management device according to one embodiment of the present invention;

FIG. 4A and FIG. 4B are graphs each illustrating a normal state and a current state displayed by an information display device according to a first embodiment of the present invention;

FIG. 5 is a view showing a table of a management action reference;

FIG. 6 is a view showing a manufacturing system management method using a manufacturing information management system according to a second embodiment of the present invention;

FIG. 7 is a view showing a failure code master data table in the data management device according to a third embodiment of the present invention;

FIG. 8 is a view showing a flow of an inputting method relevant to a failure code in one embodiment of the present invention;

FIG. 9 is a block diagram of a manufacturing management system according to another embodiment;

FIG. 10 is a view showing a flow of process for registering a failure phenomenon;

FIG. 11 is a view showing a graph depicting a transition of pass rate which is displayed on a display device;

FIG. 12 is a view showing a graph depicting a failure phenomenon analysis;

FIG. 13 is a Pareto diagram of failure factor;

FIG. 14 is a view showing a relation between failure phenomenon and factor analysis;

FIG. 15 is a view showing a data cube;

FIG. 16 is a view showing a display example of a display device; and

FIG. 17 is a view showing the other display example of the display device.

### DETAILED DESCRIPTION OF THE INVENTION

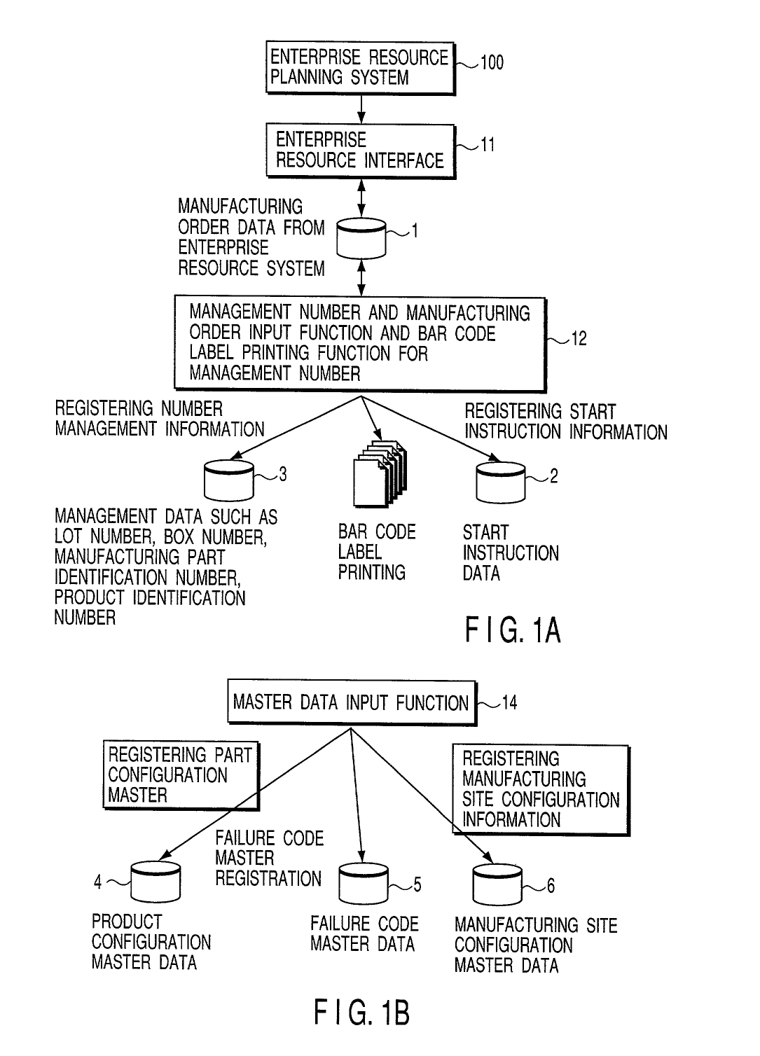

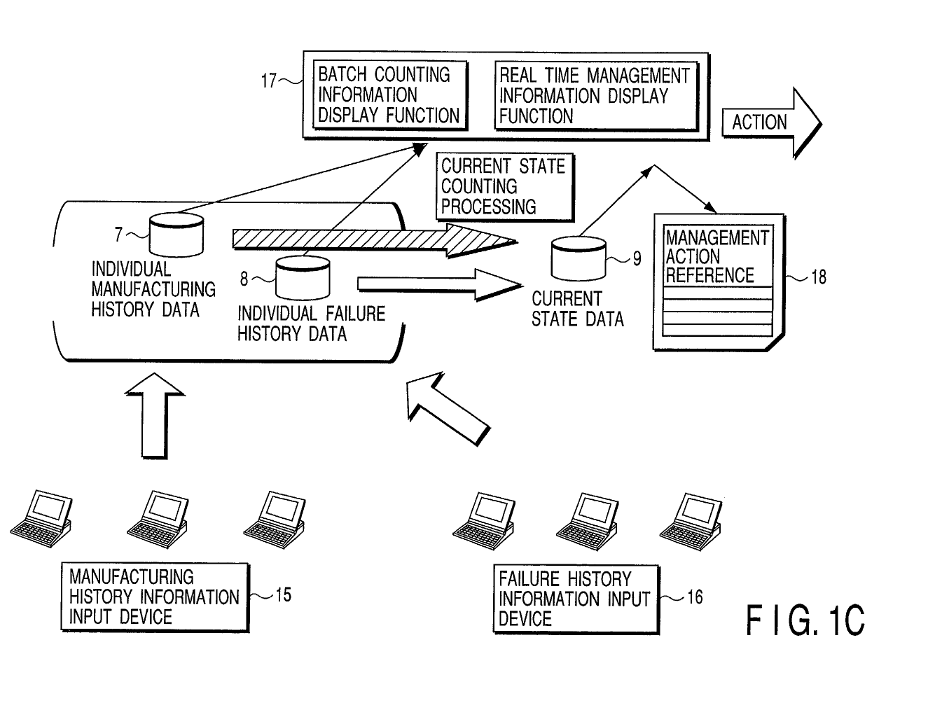

A manufacturing information management system according to a first embodiment of the present invention will be described with reference to FIG. 1A to FIG. 1C.

As shown in FIG. 1A, an enterprise system interface 11 serves manufacturing order data saved in an enterprise resource planning system 100 or the like to a database 1. A data input/output device 12 has a management number and manufacturing order input function for ordering manufacturing to a manufacturing site, and a bar code label printing function for the management number. This device acquires from the database 1 the manufacturing order data supplied from the enterprise resource planning system 100. The data input/output device 12 has a data management function for delivering the start instruction data stored in a start instruction database 2. Also, this device 12 issues to a database 3 number management data concerning a lot number, a box number, a manufacturing individual identification number, and product individual identification number. In addition, associating a respective number with another number is performed in this number management database 3.

As shown in FIG. 1B, product configuration master data is provided as a configuration master indicating a part configuration by product type, and is stored in a database 4. This product configuration master data is inputted to the database 4 by means of a master data input device 14.

Information such as failure codes, detailed descriptions of failures, or failure categories is prepared as failure code master data, and is stored in a database 5. This data is inputted to the database 5 by means of the master data input device 14. In addition, information such as line configuration or shift configuration of manufacturing site such as factory or manufacturing shop or process configuration in line is prepared as manufacturing site configuration master data, and is stored in a database 6 by means of the master data input device 14.

As shown in FIG. 1C, individual manufacturing history data or individual failure history data is stored n databases 7 and 8. A label with its individual identification number bar code for registry or manufacturing instructions with its manufacturing instruction number bar code or the like is printed by a label output device (not shown).

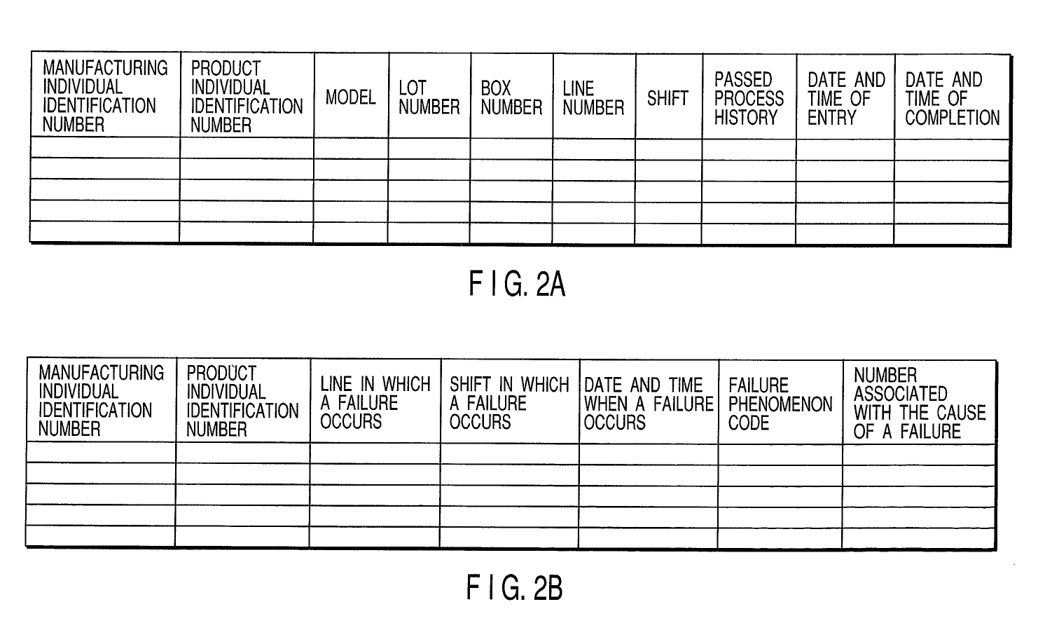

Individual manufacturing history data is inputted to a database 7 by means of a manufacturing history information input device 15. This manufacturing history information input device 15 presets what input item is allocated and what process the input item is allocated in. The result indicating that the process is passed, started or completed is inputted to an individual manufacturing history database 7 by reading an individual identification number bar code. Here, an exemplary configuration of individual manufacturing history data is shown in FIG. 2A.

Failure information produced in a manufacturing process or an inspection process is inputted to an individual failure history database 8 via a failure history information input device 15. This data is stored in the individual failure history database 8 in the form of being annexed to the manufacturing individual identification number with reference to the failure code master data 7. An exemplary configuration of individual failure history data is shown in FIG. 2B and FIG. 2C.

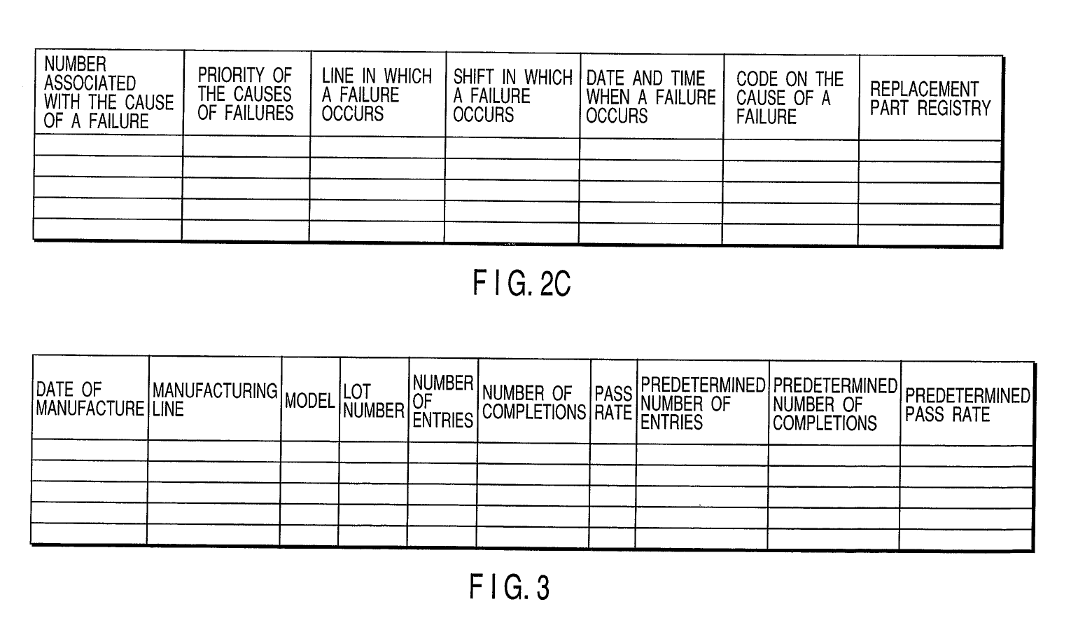

Through such processing, the individual manufacturing history data stored in the individual manufacturing history database 7 and the individual failure history data stored in the individual failure history database 8 are counted to current state data in a current state database 9 any time. The current state data is counted in a minimum management unit required for real time manufacturing and management. This management unit is configured so as to enable a combination suitable to a manufacturing site by line, by model, by date, or by shift and the like. An exemplary configuration of the current state database 9 is shown in FIG. 3.

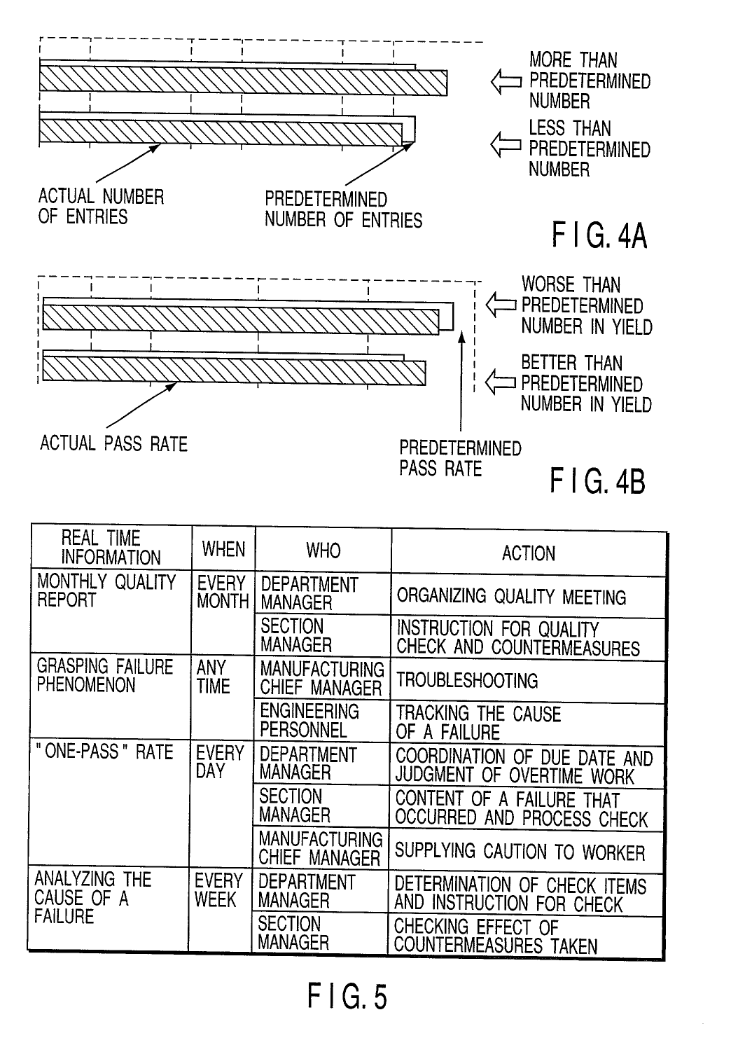

In addition, a real time management information display function in an information display device 17 displays such difference between the current state and a normal state as to lead to a manufacturing management action by using the current state database 9. An example showing the difference the current state and the normal state is shown in FIG. 4A and FIG. 4B each.

A batch counting information display function in the information display device 16 counts failure history data by using a method of specifying a period at which past failure data has been specified, and displays the data in the form of a report. An example of the thus specified method includes a graph depicting a transition of pass rate (rate of failure-free shipment) in one month by line or by shift or a relationship between the causes of failures in order from a larger number of failures that occurred.

A management action reference table 18 matrixes who takes action and what and how to take action, particularly relevant to a change of real time management information. An example of the management action reference is shown in FIG. 5. By using the management action reference tailored for a management hierarchy of a manufacturing site, one can take action immediately to solve a problem using manufacturing management information displayed by the manufacturing information management system.

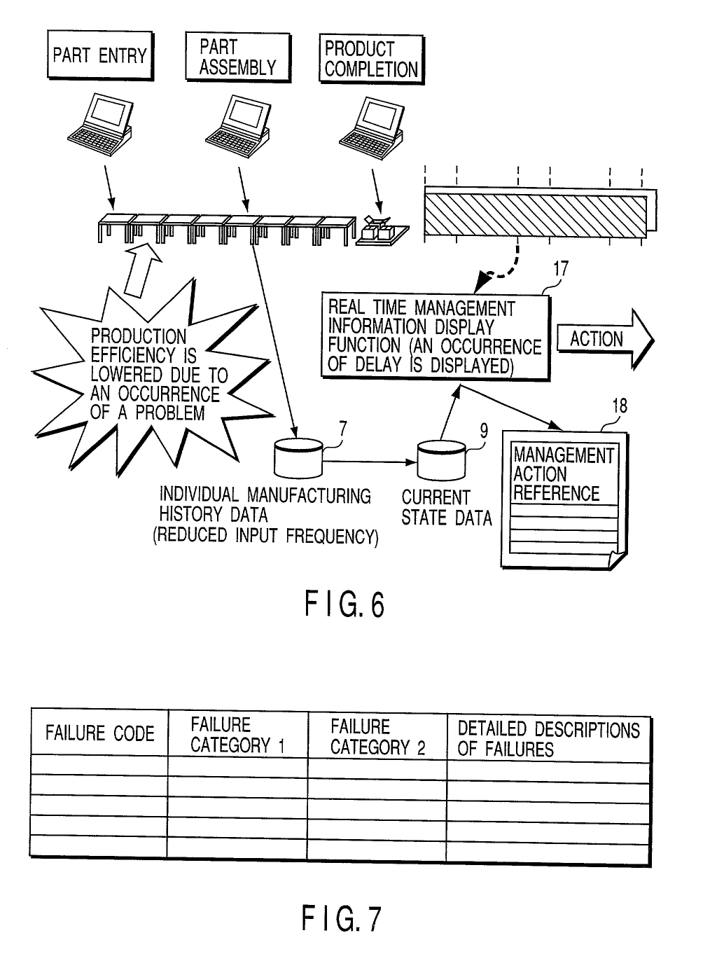

A second embodiment of the present invention will be described with reference to FIG. 6. In the manufacturing line, products are completed via parts supply and parts assembly stations. When a trouble occurs between the parts supply and parts assembly stations on the production lines, the manufacturing capability is reduced. As a result, throughput is lowered.

In this case, a real time management information display function produces a display indicating that a current throughput is evidently lower than a scheduled throughput (product efficiency). An administrator who saw the display of the real time management display function takes action immediately in accordance with the management action reference table 18 that corresponds to his or her roles. At a manufacturing site, as a result of the administrator's action, an action of shooting this trouble is taken, and immediate problem solution is effected.

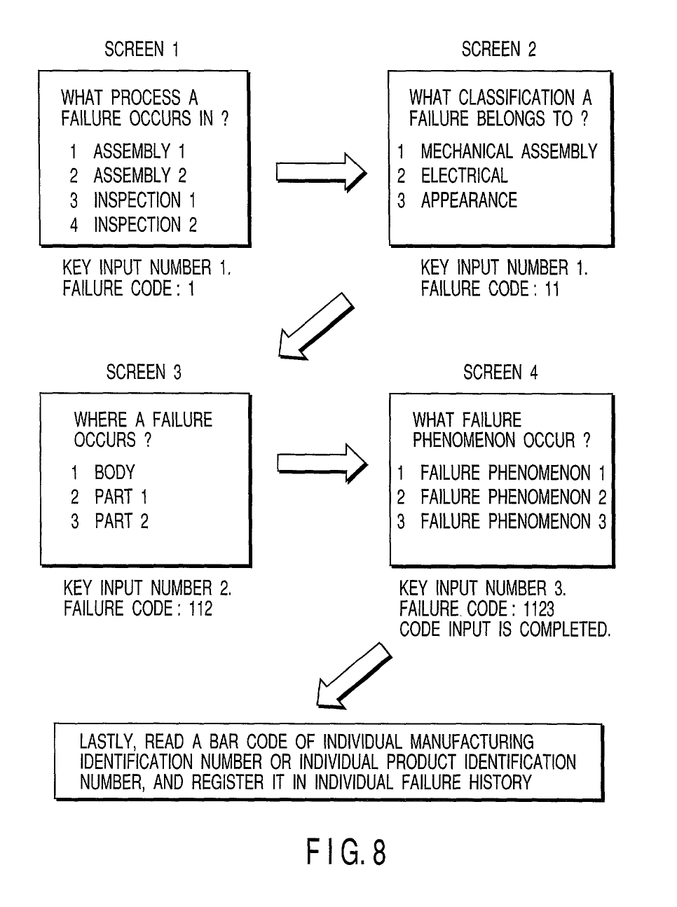

A third embodiment of the present invention will be described with reference to FIG. 7 and FIG. 8. In the present embodiment, failure master data is classified by category as shown in FIG. 7. failure states are input every management number by an input device for failure history information in accordance with the hierarchy from a upper category to a lower category as shown in an input screen of FIG. 8, and a desired failure code is finally inputted.

Lastly, a bar code of a bar code label attached to manufacturing individual identification number or product individual identification number is read, whereby the failure code and individual identification number are registered as failure history data in a manufacturing information management system.

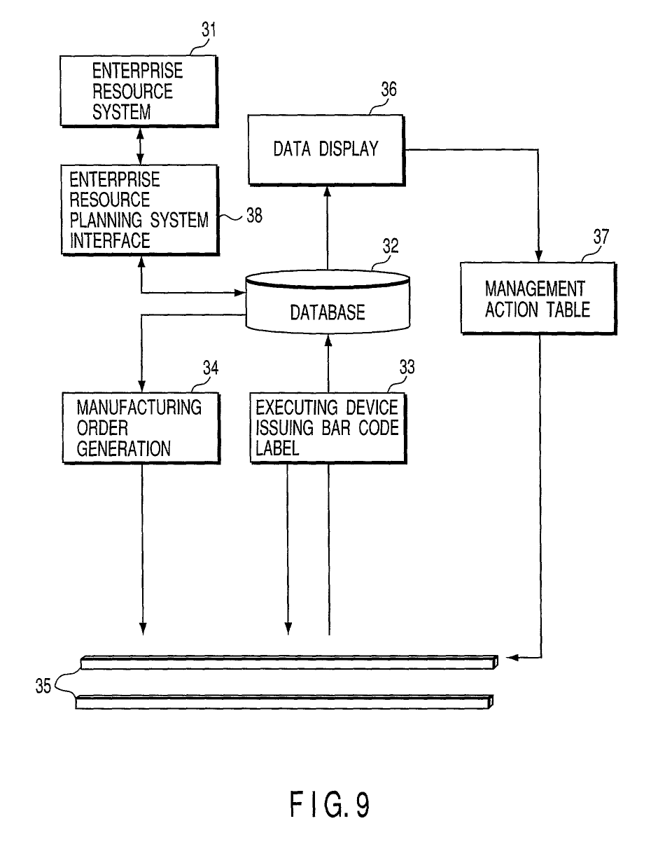

Now, a fourth embodiment of the present invention will be described with reference to FIG. 9. According to the present embodiment, a manufacturing management system comprises an enterprise resource planning system 31 for instructing a product manufacturing plan, a database 32 for storing information produced from this enterprise resource planning system 31, an executing device 33 for performing data acquisition based on the stored information in this database 32, issuing a bar code label concerning a product and collecting manufacturing information, a manufacturing order issuing device 34 for issuing manufacturing order information based on the information contents of the database 32 to a manufacturing line 35, and a graphical data display device 36 for graphically displaying analysis contents. A management action table 37 describes an action to be taken by an administrator based on information displayed on the data display device 36, for example, progress, quality report and failure analysis.

In a configuration shown in FIG. 9, when the enterprise resource planning system 31 receives an instruction from a production administrator as to a monthly or weekly plan for manufacturing products, for example, 100 personal computers, the system stores production plan information in the database 32 via an enterprise resource planning system interface 38. The interface 38 receives a manufacturing plan from the enterprise resource planning system 31, and sends complete results thereto. The executing device 33 issues a bar code label for parts relevant to a product based on the production plan information.

On the other hand, the manufacturing order issuing device 34 supplies a manufacturing instruction to a manufacturing line 35 based on the production plan information. In this way, parts flow in the line 35. At this time, the previously mentioned bar code label is attached to each of the parts.

When products flow the manufacturing line 35, the bar code of each product is read by a bar code scanner (not shown). The read bar code information is registered in the database 32. In this case, basic data such as part configuration of the product that corresponds to a bar code label number, a time when it is manufactured or a shift in which it is manufactured is registered in the database 32. In addition, data indicating that information from the enterprise resource system should be printed on the bar code label, data indicating that a bar code has been issued, and information indicating the start and end numbers of bar codes, are stored in the database 32. Further, information indicating where products pass in line is acquired as manufacturing history. When a failure occurs, individual failure data is produced as an input of the failure to generate individual failure data. These types of data is acquired, whereby the current state data can be produced in real time.

As described above, the bar code of a bar code label is read, thereby making it possible to trace where a product is, when it is manufactured and what parts are used. The trace data is stored in the database 32 in real time. The trace data is counted, and is visualized, or graphically displayed on the data display device 36 in order to acquire information required for manufacturer's factory management at a normal stage at which the administrator keeps a due date and improves quality based on the information stored in the database 32. By referring to this graph, a human based management reference on who does this or what to do is incorporated in a system so as to ensure an efficient and high productive manufacturing site in a factory itself.

In reality, who does this or what to do is determined and tabulated based on the graph obtained in the system, and one takes action in the manufacturing site by referring to the table. One judges a delay in manufacturing line by referring to the displayed graph. In the graph shown in FIG. 4, if a partial graph indicating a delay, for example, increases, a warning is issued. Alternatively, one can see how is the production in progress or failure rate, or an increased number of unfinished products. Failure items can be traced based on bar code information, and thus, such failure items can be fed back to a parts vender.

Further, the past results and the prediction are assumed to be displayed a blue bar and a red bar, respectively. In this time, if the result is lower than prediction, a red bar is protruded and displayed. Otherwise, a blue bar is protruded and displayed. In this way, it is judged whether or not an abnormality occurs.

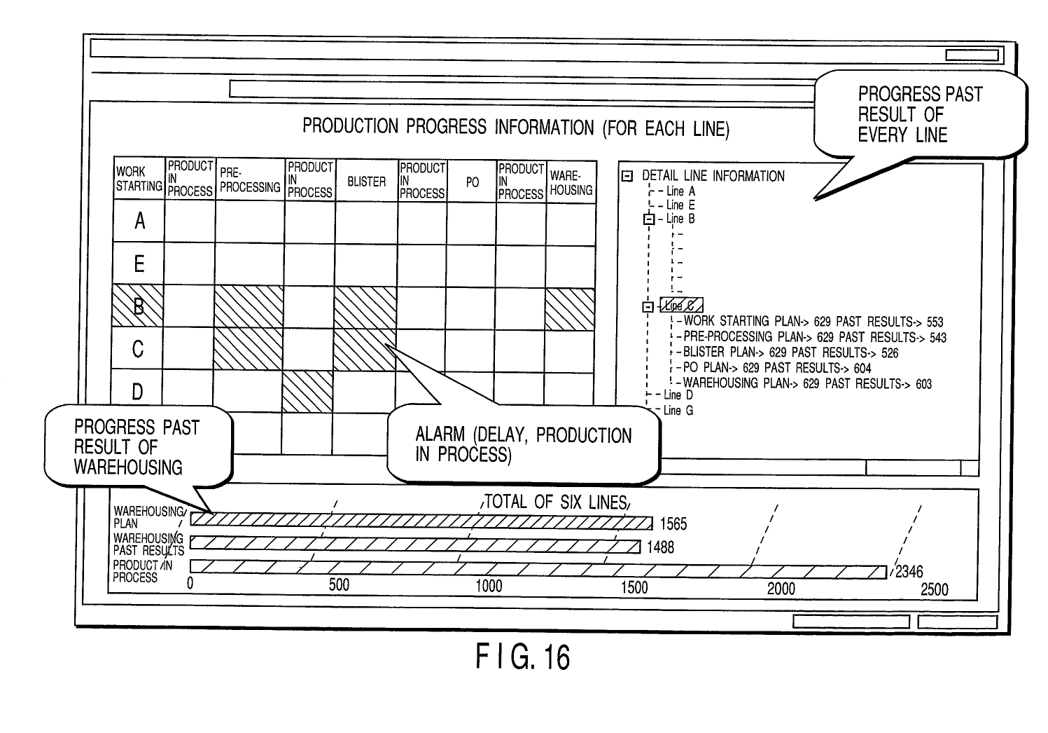

A pass rate is used to determine whether or not an abnormality occurs. This pass rage is defined as follows. That is, if all products are passed at one test without any failure, it is referred to as “one pass”. Even if one failure is found, it is referred to as “non-pass”. The rate of “one-pass” to all entries is referred to as “one-pass rate”. This pass rate is individually displayed. If the pass rate drops, it is judged that a failure occurs. The content of a failure is displayed every line when the pass rate drops. In this case, the screen of the display device 36 is divided into three areas. For example, three areas capable of displaying a manufacturing line progress result for each line, a delay for each line, and a progress of entire lines and alarm, respectively, is provided on the display screen as shown in FIG. 16. Only the plan and the past results are displayed on the display area for the manufacturing line progress result in FIG. 16. However, the display area may display another item such as product in progress or difference between progresses.

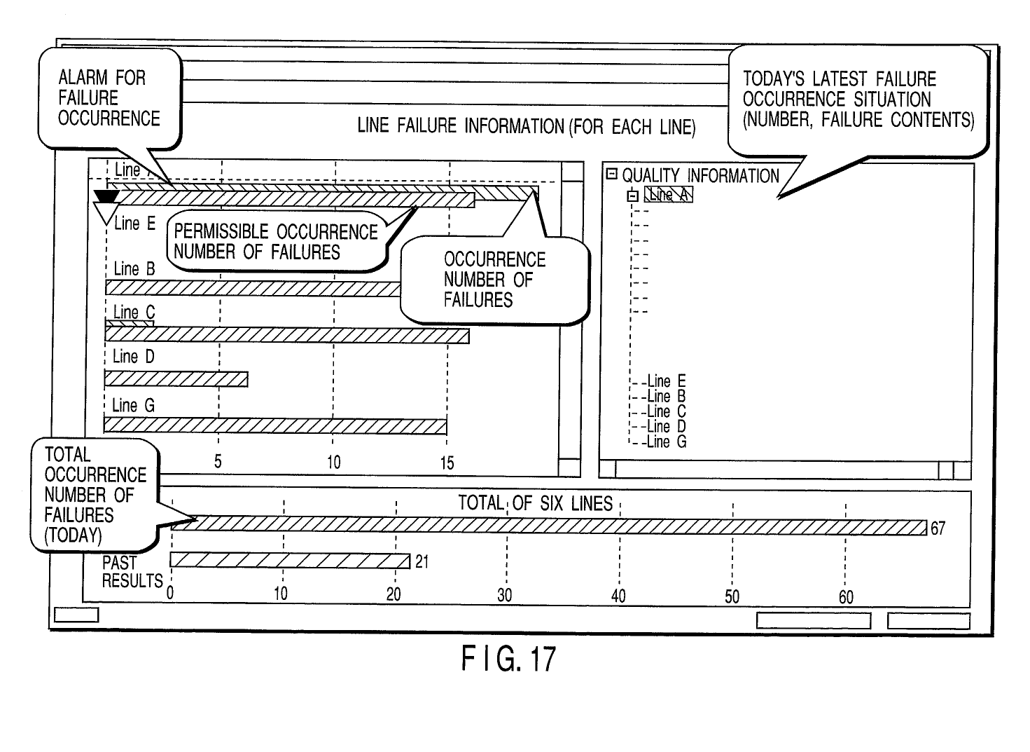

FIG. 17 shows another display example having areas for displaying a failure state for each line, failures of all lines and alarm, and progress of all lines, respectively.

When any one of the lines displayed as described above is clicked, detailed information such as the number of failures, whether or not production is slow in progress or why the production is slow in progress is displayed for each manufacture line as shown in FIG. 17.

The administrator judged what to do next if he or she finds that production is slow in progress by referring to the graph. At this time, character information is clicked in order to see what happens. In this way, the administrator can see what failure occurs, where such failure frequently occurs. Based on this information, the administrator judges where or what to do. Thus, there can be provided directly related information for the administrator to take action in real time so that the administrator can take action by referring to production in progress and failure rate as a fundamental base.

Now, action for the administrator to take when a failure occurs will be described here.

The administrator sees what process a failure occurs in by referring to a lowered pass rate. At this time, the number of failures that have occurred is displayed by each process. In this way, a process in which failures occur most frequently can be judged. There is provided character information indicating classification of failures in that process. Then, a location where such failure occurs and what phenomenon occurs are displayed by pulling them down. Based on this display, when it is identified as to what process the failure occurs in, what is the classification of the failures, and where the failure occurs, it is found that a failure occurs with product A in location M, for example. In this way, the administrator can know what happened in process P, and take countermeasures.

Now, failure analysis performed at the executing device 33 will be described here. Failure data is inputted from line 35 for the purpose of analysis. Screen data for inputting failure data and the corresponding failure data are stored in the database 32, and are registered therein. These types of data are roughly classified by the phenomena and causes of failures when they are stored.

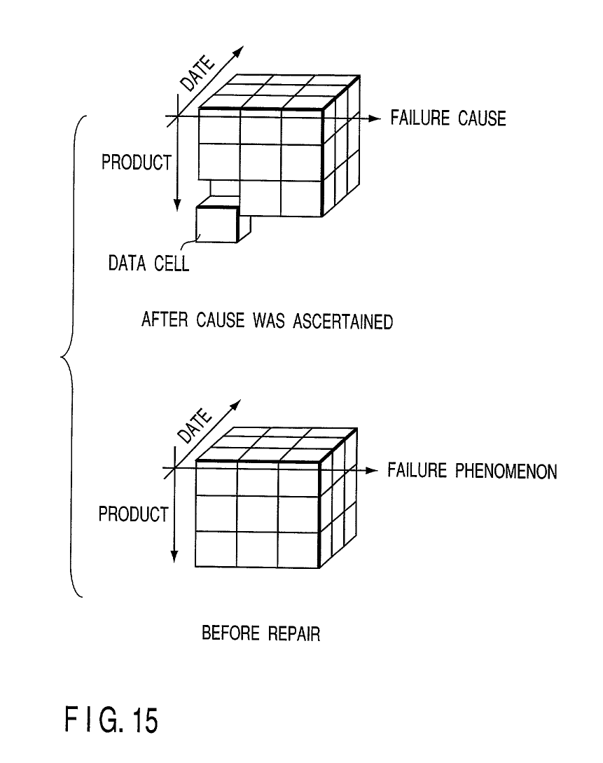

This failure information is defined in minimum units of time, line, and process. Then, the number of failures that occurred is counted by failure type or the number of products. Thus, failure phenomena and failure causes are accumulated by counting various types of data. The accumulation is performed in minimum units for all failure phenomena and causes. The contents of one data type are counted by being grouped in minimum management units of line, process, date, model, failure phenomenon, cause of failure, processing, location, or department and section. This is called a data cube. As shown in FIG. 15, data generated in line is distributed in a primary data cube at the same time when the manufacturing history of individual products and failure history are registered.

Now, information what and how many times failures occur is stored in a data cube for counting failures when data is registered. The information include the phenomena of failures, for example, a phenomenon in which no screen is displayed or no power is supplied. If a failure phenomenon occurs, the cause of such failure is investigated. The causes of failures include soldering failure line disconnection, incorrect parts mounted. These causes are inputted to the database 32 after being corrected. Then, there are produced two data cubes, i.e., one data cube (phenomenon data cube) in which failures occur and the other data cube (cause data cube) in which the failures are corrected. After these data cubes are produced, the cubes can be selected on a screen. For example, there are set types of analyses such as line type, shift type, process type, data classification of model, classification of failure, failure period, the contents of analyses based on transition of pass rate, actual analysis, or palate analysis, or analysis of association between phenomena and causes. On the basis of such analysis types, for example, the contents such as starting and ending times a day or transition of line failure rate a day are acquired from a data cube. These contents indicate that failure phenomena are categorized in order from the largest number of failures, the categories are listed in order from the largest number of failures, and what failure occurs as a group of details therein. What is an amount of five cases in all is acquired from the phenomenon data cube. From the cause data cube, the causes of failures occurred in a predetermined period are listed in order from the largest number of failure causes, and 10 causes of failures are palate analyzed so as to identify the largest number of failure causes. This is obtained by investigating the failure causes from the failure phenomena. Next, the causes of phenomena that occur are identified by referring to the classification of phenomena that occur. Based on this result, the quality administrator judges what to do next in order to improve quality.

Now, failure code master data stored in the database 32 will be described here. When failure information is inputted, this failure code master data is used to determine the number of code according to failure type by encoding various codes generated when failures are managed at factory. For example, there occurs failure phenomena in which operation is impossible during product check or nothing is displayed on computer screen. In this case, there occurs a phenomenon in which failure master data is not displayed on a screen, and the code consists of three digits A15. When this A15 is inputted, a failure (screen failure) is registered. One can grasp the content of a failure by referring to this code.

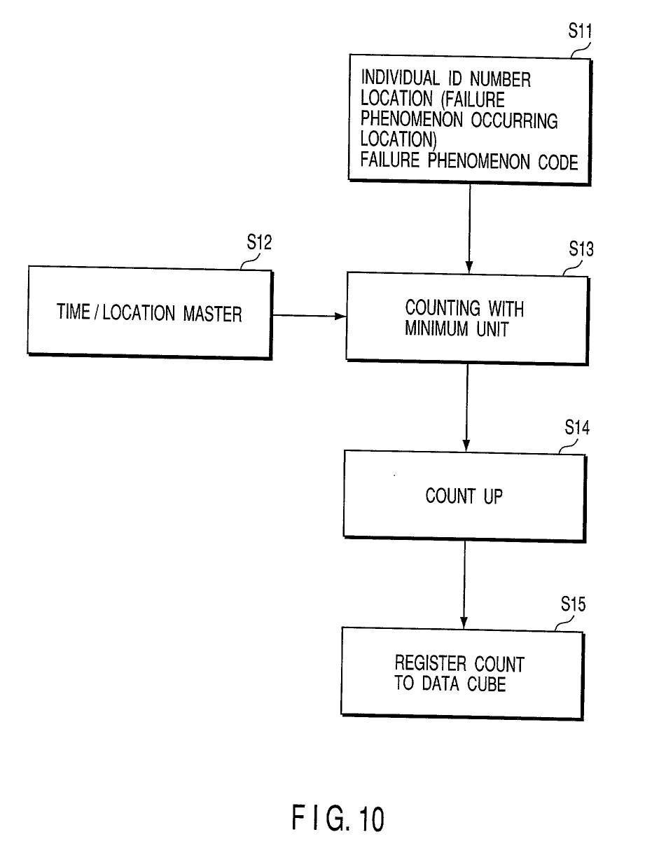

Now, a method of registering the above data cube will be described with reference to FIG. 10. First, data such as individual identification number, location where a failure occurs, and failure phenomenon codes is inputted (S11). To this data, there are added a time and location master, i.e., location code location (line and station) (S12). The data to which the time and location master have been added is divided into minimum units (S13). When this data is generated once, counting up operation is made in minimum units by referring to the count in minimum units (S14). This count-up is registered in a data cube (Sl5). In this case, the minimum unit is determined by referring to the count when data is inputted. Counting is done based on the conditions for such minimum units, and data cube registration is performed by referring to the count. This registration applies to cases of failure phenomena and causes. The error causes are composed of location, line, or date divided in minimum units, and the number of slice obtained by dividing a day.

In the meantime, in the manufacturing management system according to the embodiment of the present invention, all data is stored in a database, and required information is displayed from the database. The items of lines or failures are almost identical to each other in the storage database whatever is manufactured at factory such as computers, refrigerators, televisions. Conventionally, there have been provided many types of databases suitable to various factories. However, according to the present invention, the specific database is provided as a template, that is, as a basic function. As a result, if only specific parts at that factory are optionally customized, the database can be applied immediately to any factories. Various data are collected, a recording table is defined, and there is employed a template in which all the desired items are entered in the table, whereby data can be written in the same table according to factory type. This template is identical on a screen so that, if an abnormality occurs, adequate action may be taken. Therefore, the screen can be used in common. The screen is also provided such that common items are produced in advance, and customized items are produced individually.

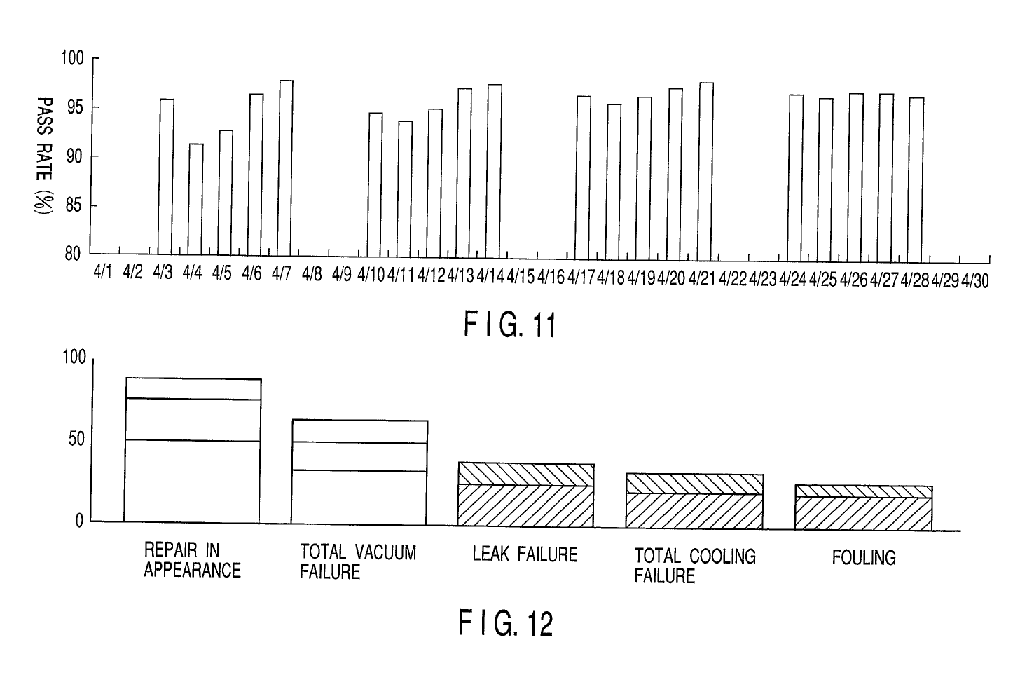

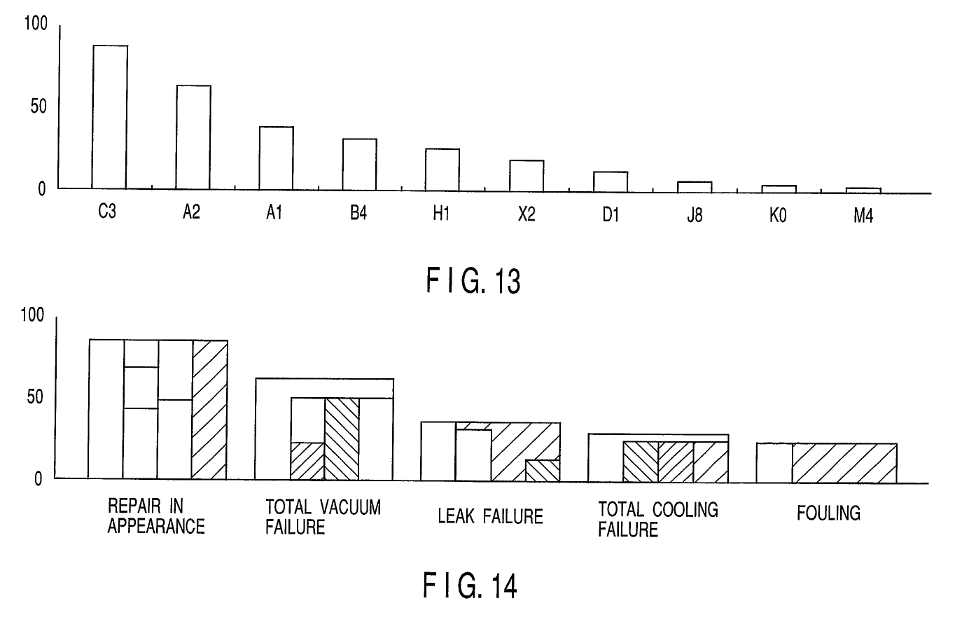

The analysis result obtained as described above is displayed on the display device 36 for the purpose of the administrator judgment. FIG. 11 to FIG. 14 each show pass rate, analysis of failure phenomena, failure cause palate, and analysis of failure phenomena/cause. The administrator determines what to do by referring to these displayed analysis results.

In the foregoing, although a description has been given with respect to the embodiments of the present invention, these functions are stored in an optical disk such as CD-ROM or DVD or a storage medium such as semiconductor memory, whereby the function can be executed by a commercially available computer. Of course, the present invention can be modified variously without being limited thereto. Hereinafter, the various modifications will be described. In the above described preferred embodiments, although the functions that belong to respective means are shared each other, and are separated from each other, there may be provided a structure in which these functions are separated from each other or are combined with each other according to the circumstance of the manufacturing site.

Further, in the above described preferred embodiments, although an exemplary data configuration has been described, data items can be registered after being shared each other or after being separated from each other.

A data input function assumes bar code input, but key input may be available. Voice or image may be inputted instead of key input.

Further, although a difference from a predetermined state is described by two graph representations, this difference may be indicated by an alarm or any other image.

According to the present invention described above, real time information and counting information are clearly distinguished from each other, and a human based management action reference is defined as a part of the system, thereby making it possible to take quick management action based on displayed manufacturing information.

In addition, by clearly distinguishing real time information and counting information, quick management action can be taken based on manufacturing information displayed by a manufacturing system management method using a manufacturing information management system in which the human based management action reference is defined as a part of the system.

In data input, hierarchically grouped failure codes are provided as failure master data; the failure codes are displayed on a screen in order from the highest hierarchy; the codes advances to the lower hierarchy every time an operator selects screen display items, and the failure codes can be finally inputted, whereby input operation of failure data can be simplified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A manufacturing management apparatus associated with an enterprise resource planning system for performing management concerning a manufacturing product quantity and a manufacturing process, comprising:
an interface configured to input manufacturing order information from the enterprise resource planning system;
an information management device configured to manage data concerning individual parts employed for manufacture according to the manufacturing order information, and output information to be provided to the parts; and
an information display device configured to generate manufacturing information in a manufacturing process employing the parts based on data managed by the information management device, and display the manufacturing information in the form of management action reference auxiliary information.

2. A manufacturing management apparatus as claimed in claim 1, wherein the data management device is configured to manage work starting data, management data concerning lot numbers, box numbers, individual manufacturing identification number, and individual product identification numbers, product configuration master data, failure code master data, manufacturing site configuration data, individual manufacturing history data, individual failure history data, and current state data.

3. A manufacturing management apparatus as claimed in claim 1, wherein the input device comprises a work starting data input function for a manufacturing number and a manufacturing site, a master data input function, a manufacturing history data input function, and a failure history data input function.

4. A manufacturing management apparatus as claimed in claim 1, wherein the information display device comprises a batch counting information display function and a real time management information display function.

5. A manufacturing management apparatus as claimed in claim 1, wherein the information management device comprises a function for printing a bar code label as information to be provided to parts concerning manufacturing information.

6. A manufacturing management apparatus associated with an enterprise resource planning system for instructing a product manufacturing plan, comprising:
a database configured to store information generated from the enterprise resource planning system;
a label issuing device configured to issue to each part a bar code label concerning the each part based on storage information in the database;
an executing device configured to read a bar code of a bar code label of each part that flows a manufacturing line, to store readout bar code data in the database; and
a display device configured to generate manufacturing information in a manufacturing process based on information stored in the database, and displaying the manufacturing information as management action reference auxiliary information.

7. A manufacturing management apparatus as claimed in claim 6, wherein the executing device is configured to acquire information indicating where parts pass in line as manufacturing history information, and when a failure occurs, generate individual failure data as an input of failures, and generate current state data in real time by acquiring these data.

8. A manufacturing management apparatus as claimed in claim 7, wherein the executing device is configured to count manufacturing history information and failure data to obtain counting information, and graphically displays the counting information on the display device.

9. A manufacturing management apparatus as claimed in claim 1, wherein the display device is configured to display an area for displaying progress states or failure states for all lines, an area for displaying a progress delay alarm or a failure alarm for each line and an area for displaying a progress state or a failure state for each line.

10. A manufacturing management method, wherein an action concerning manufacturing management is taken based on the display caused by the display device, using the manufacturing management apparatus of claim 1.

11. A manufacturing management method comprising:
inputting manufacturing order data from an enterprise resource planning system for performing management concerning a manufacturing product quantity or a manufacturing process;
managing data concerning individual parts employed for manufacture according to the manufacturing order data to output information to be provided to the parts;
generating and displaying manufacturing information in the manufacturing process using the parts based on the data managed in the managing step; and
determining a management action reference by referring to the displayed manufacturing information.

12. A manufacturing management apparatus as claimed in claim 11, comprising:
displaying hierarchically categorized failure codes in order from the highest hierarchy while providing the failure codes as failure code master data, when failure history data is inputted in the data input step,
advancing to a lower hierarchy every time a displayed failure code is selected by an operator; and
finally inputting a predetermined failure code.

13. A manufacturing management method comprising:
storing in a database, information generated from an enterprise resource planning system for instructing a product manufacturing plan;
issuing to each part, a bar code label concerning the part based on storage information in the database;
reading a bar code of a bar code label of each part that flows a manufacturing line to obtain bar code data,
collecting the bar code data to store the collected bar code data in the database;
generating manufacturing information in a manufacturing process based on the information stored in the database; and
displaying the manufacturing information as management action reference auxiliary information on a display device.

14. A manufacturing management method of claim 13, wherein the data collecting step includes extracting information indicating where parts pass in a line as manufacturing history information, producing individual failure data as an input of a failure when the failure occurs; and collecting these data to produce current state data in real time.

15. A manufacturing management method of claim 14, wherein the data collecting step includes counting manufacturing history information and failure data to obtain count information, and graphically displaying the count information on the display device.

16. A manufacturing management method as claimed in claim 14, wherein the displaying step includes displaying an area for displaying progress states or failure states for all lines, an area for displaying a progress delay alarm or a failure alarm for each line and an area for displaying a progress state or a failure state for each line.

17. A computer program product for operating a computer, comprising:
means for instructing the computer to input a manufacturing instruction data from a superior system for performing management concerning a manufacturing product quantity and a manufacturing process;
means for instructing the computer to manage data concerning individual parts employed for manufacture according to the manufacturing instruction data to output information to be provided to the parts; and
means for instructing the computer to generate and display manufacturing information in the manufacturing process as management action reference auxiliary information using the parts based on the data managed in accordance with the managing instruction means.

18. A computer program product for operating a computer, comprising:
means for instructing the computer to store in a database, information generated from an enterprise resource planning system for instructing a product manufacturing plan;
means for instructing the computer to issue to each part, a bar code label concerning the each part based on storage information in the database;
means for instructing the computer to read a bar code of a bar code label of each part that flows a manufacturing line, collect data, and then, store collected data in the database;
means for instructing the computer to generate manufacturing information in a manufacturing process based on the information stored in the database; and,
means for instructing the computer to display the manufacturing information as management action reference auxiliary information on a display device.

19. A computer program product for operating a computer as claimed in claim 18, wherein the displaying instructing means includes means for instructing the computer to display an area for displaying progress states or failure states for all lines, an area for displaying a progress delay alarm or a failure alarm for each line and an area for displaying a progress state or a failure state for each line.
